(19) United States
(12) Patent Application Publication
(10) Pub. No.: US 2026/0241934 A1
(43) Pub. Date: Aug. 20, 2026

(54) METHOD FOR CONTROLLING A VEHICLE, VEHICLE CONTROLLER AND A VEHICLE

(71) Applicant: AUMOVIO Autonomous Mobility Germany GmbH, Ingolstadt (DE)

(72) Inventors: Toru Hasegawa, Yokohama City, Aoba Ku (JP); Yuta Nakajima, Minami Ku, Yokohama City (JP); Takahiro Kawai, Kanagawa Ku, Yokohama City (JP); Yuki Kanamori, Yokohama City, Kanagawa Ku (JP)

(73) Assignee: AUMOVIO Autonomous Mobility Germany GmbH, Ingolstadt (DE)

(21) Appl. No.: 19/159,497

(22) PCT Filed: Feb. 22, 2024
(86) PCT No.: PCT/EP2024/054464

§ 371 Date: Aug. 25, 2025

(30) Foreign Application Priority Data
Feb. 27, 2023 (GB) 2302832.7

(51) Int. Cl. B60W 30/18

(52) U.S. Cl. CPC B60W 30/18154; B60W 30/181; B60W 2552/53; B60W 2554/802

(57) ABSTRACT

According to various embodiments, a computer-implemented method for controlling a vehicle may be provided. The method may include detecting presence of at least one of a stop line and a traffic light ahead of the vehicle, based on data generated by a sensor of the vehicle. The method may further include detecting presence of a road intersection ahead of the vehicle, based on digital map data. The method may further include generating a virtual stop line based on non-detection of presence of a stop line in combination with detection of presence of at least one of a traffic light and a road intersection. The method may further include generating instructions for decelerating the vehicle based on the virtual stop line.

### CROSS-REFERENCE TO RELATED APPLICATIONS

This application is the U.S. National Phase Application of PCT International Application No. PCT/EP2024/054464, filed Feb. 22, 2024, which claims priority to GB Patent Application No. 2302832.7, filed Feb. 27, 2023, the contents of such applications being incorporated by reference herein.

### FIELD OF THE INVENTION

Various embodiments relate to methods for controlling deceleration of a vehicle, deceleration controllers and vehicles.

### BACKGROUND OF THE INVENTION

Advanced driver assistance systems have become indispensable in improving road safety. They may reduce the workload of drivers by supplementing the drivers with critical information, suggesting actions to be taken, and even automatically performing functions as necessitated by the driving scenario. In urban driving scenarios, drivers often need to apply brakes, for example, to stop at traffic junctions and stop signs. An advanced driver assistance system may assist the driver in this aspect, by triggering a braking function when the system detects a stop line. A stop line is typically a visual road marking before a road intersection or road crossing, that informs drivers that they need to stop the vehicle before the stop line. However, the stop line is not always detectable. For example, the advanced driver assistance system may fail to detect the stop line when the lighting conditions are poor, or if the road is poorly maintained and the stop line has faded. If the driver is inattentive in such scenarios where the advanced driver assistance system fails to trigger the braking function, an accident may occur as the vehicle may collide with cross traffic or knock into pedestrians as it moves past the stop line. As such, there is a need for an improved method for controlling the brake

### SUMMARY OF THE INVENTION

According to various embodiments, there is provided a computer-implemented method for controlling a vehicle. The method may include detecting presence of at least one of a stop line and a traffic light ahead of the vehicle, based on data generated by a sensor of the vehicle. The method may further include detecting presence of a road intersection ahead of the vehicle, based on digital map data. The method may further include generating a virtual stop line based on non-detection of presence of a stop line in combination with detection of presence of at least one of a traffic light and a road intersection. The method may further include generating instructions for decelerating the vehicle based on the virtual stop line.

According to various embodiments, a vehicle controller may be provided. The vehicle controller may include a processor. The processor may be configured to perform the abovementioned method for controlling a vehicle.

According to various embodiments, a vehicle may be provided. The vehicle may include a sensor unit and the abovementioned vehicle controller. The sensor unit may be configured to generate data indicative of objects ahead of the vehicle.

According to various embodiments, a computer program product may be provided. The computer program product may include instructions that when the program is executed by a computer, cause the computer to carry out the steps of the abovementioned method for controlling a vehicle.

Additional features for advantageous embodiments are provided in the dependent claims.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of aspects of the invention. In the following description, various embodiments are described with reference to the following drawings, in which:

FIGS. 1A to 1E show use case scenarios of a method of controlling a vehicle according to various embodiments.

FIG. 2 show a flow chart of a method for controlling a vehicle according to various embodiments.

FIG. 3 shows a flow diagram of a computer-implemented method for controlling a vehicle 108 according to various embodiments.

FIG. 4 shows a simplified block diagram of a vehicle controller according to various embodiments.

FIG. 5 shows a simplified block diagram of a vehicle according to various embodiments.

### DETAILED DESCRIPTION OF EXEMPLARY EMBODIMENTS

Embodiments described below in context of the devices are analogously valid for the respective methods, and vice versa. Furthermore, it will be understood that the embodiments described below may be combined, for example, a part of one embodiment may be combined with a part of another embodiment.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In this context, the device as described in this description may include a memory which is for example used in the processing carried out in the device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In order that the invention may be readily understood and put into practical effect, various embodiments will now be described by way of examples and not limitations, and with reference to the figures.

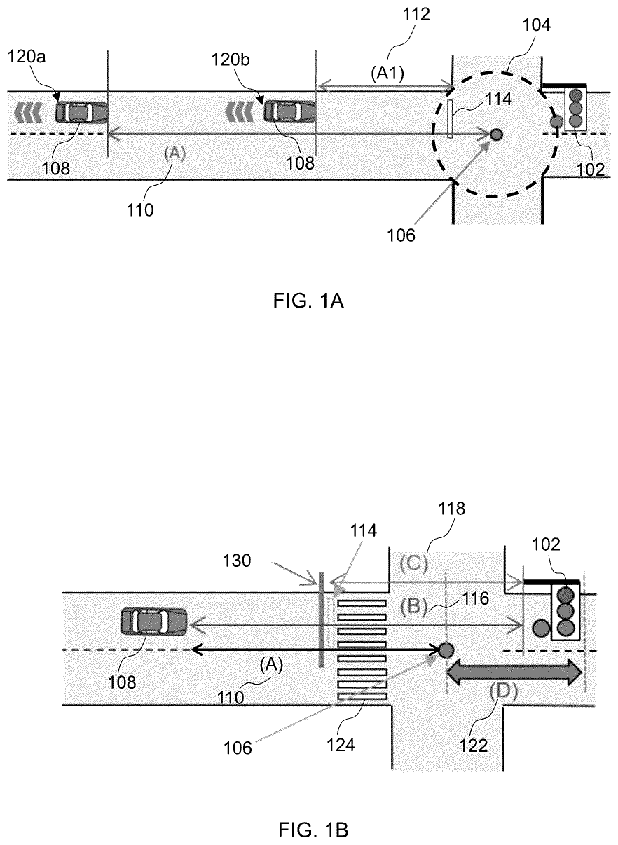

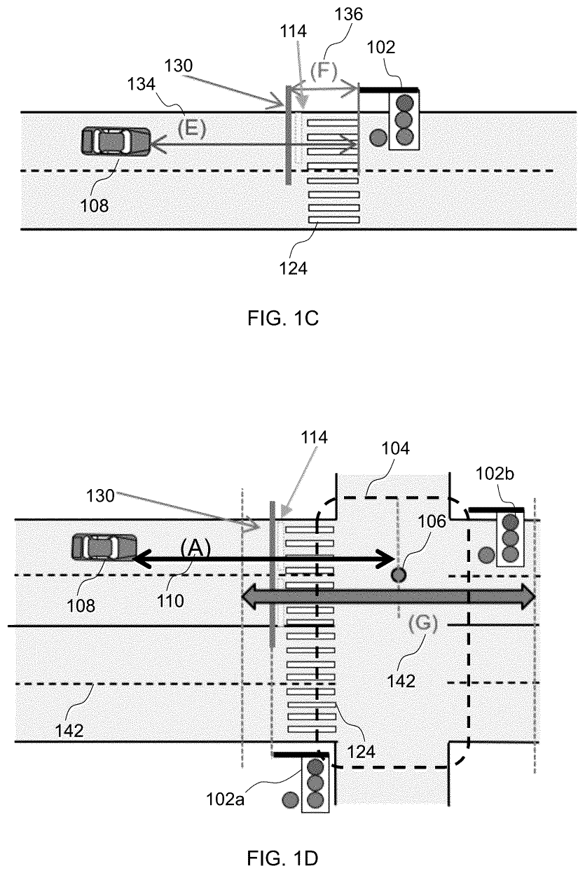

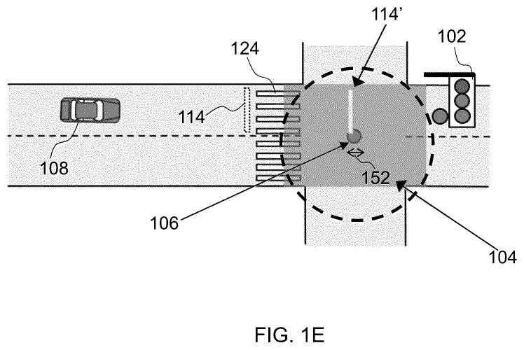

According to various embodiments, a method for controlling a vehicle may be provided. The method may include determining a need to decelerate the vehicle, thereby generating a virtual stop line and then decelerating the vehicle according to a position of the virtual stop line. Similar to a real physical stop line, the virtual stop line may serve as an indicator as to where the vehicle should stop. The virtual stop line may be generated based on data collected by surrounding environment sensors and/or digital map information. The method will be described further with respect to FIGS. 1A to 1D.

FIGS. 1A to 1E show use case scenarios of a method of controlling a vehicle 108 according to various embodiments.

FIG. 1A shows a scenario where the vehicle 108 is moving along a road towards a road intersection 104 with a single traffic light 102. A controller in the vehicle 108, also referred herein as the vehicle controller, may determine a position of the vehicle 108 relative to the road intersection 104. The vehicle controller may determine a distance (A) 110 between the vehicle 108 and a road intersection centre 106, based on digital map data and further based on position data. The vehicle controller may determine the distance (A) 110 by taking a difference between the coordinates of the road intersection centre 106 and the position of the vehicle 108. The distance (A) 110 may refer to longitudinal distance, i.e. displacement in a direction that is at least substantially parallel to traffic movement direction on the road.

The digital map data may include positional information on urban layout, including for example, position of roads, traffic lights, pedestrian crossings, bridges, expressways, and buildings. The digital map data may include positional information of the road intersection 104, and this positional information may be provided in the form of the coordinates of a centre point of the road intersection 104, also referred herein as road intersection centre 106. The vehicle controller may receive the digital map data from a digital map unit which may be installed in the vehicle 108. The digital map unit may retrieve the digital map data from a cloud server or from its in-built memory.

The position data may indicate location of the vehicle 108, for example, in the form of coordinates. The vehicle controller may receive the position data from a localization unit onboard the vehicle 108. The localization unit may include, for example, a Global Positioning System (GPS) unit and/or an Inertial Navigation System (INS) unit.

When the vehicle controller determines that the distance (A) 110 is less than a first threshold, the vehicle controller may activate a brake reaction, also referred herein as braking mode. In the braking mode, the vehicle 108 may begin to reduce its speed. The vehicle controller may activate the braking mode, regardless of whether a sensor unit on the vehicle is able to detect a stop line 114 on the road. This is useful as a preemptive safety measure, to ensure the vehicle 108 is able to stop in time before the road intersection 104, even when the stop line 114 is undetectable. The stop line 114 may be undetectable for various reasons, such as poor visibility conditions on the road or poorly maintained road that resulted in fading of the stop line 114. In the braking mode, the vehicle controller may continue to receive sensor inputs from the sensor unit. If the sensor unit provides inputs indicating detection of the stop line 114, the vehicle controller may determine a distance between the vehicle 108 and the stop line 114 based on the sensor inputs, and then determine a target stop position for stopping the vehicle, based on the determined distance. For example, the braking mode may be activated when the vehicle 108 is at position 120a where it is a first threshold distance away from the road intersection center 106. As the vehicle 108 moves forward to position 120b, its sensor unit detects the stop line 114. The vehicle controller then determines the distance (A1) 112 between the vehicle 108 and the detected stop line 114, and generates instructions to decelerate the vehicle 108 based on the distance (A1) 112. The instructions may be transmitted to the transmission module of the vehicle 108, to decelerate the vehicle 108.

Continuing from the scenario described with respect to FIG. 1A, if the sensor unit is still not able to detect the stop line 114 when the distance (A) 110 between the vehicle 108 and the road intersection center 106 is equal to or less than a second threshold, the vehicle controller may generate a virtual stop line 130. The second threshold may be shorter than the first threshold. The virtual stop line 130 may serve as an approximation of the stop line 114, and may indicate a position by which the vehicle 108 should brake to a stop. The vehicle controller may generate the virtual stop line 130 based on a combination of the digital map data and position of a detected landmark, such as a traffic light or traffic sign. The sensor unit may detect the landmark and transmit the detection data to the vehicle controller. The sensor unit or the vehicle controller, may determine or estimate the position of the detected landmark based on the detection data.

FIG. 1B shows a scenario where the vehicle 108 is approaching a road crossing 124 and a road intersection 104 with a single traffic light 102. The stop line 114 is not detected by the sensor unit. As described above, the vehicle controller may generate the virtual stop line 130 because the vehicle 108 is less than a second threshold distance away from the road intersection centre 106 as determined based on the digital map data, while no stop line 114 is detected. The sensor unit of the vehicle 108 may detect the traffic light 102 ahead of the vehicle 108. The sensor unit may include a front-facing camera, also referred herein as a front camera. The sensor unit may also determine that there is only one traffic light 102 ahead of the vehicle 108. The vehicle controller or the sensor unit may determine a distance (B) 116 between the vehicle 108 and the traffic light 102. The vehicle controller may compare the distance (B) 116 to the distance (A) 110. The vehicle controller may also determine the distance between the traffic light 102 and the road intersection centre 106 based on the distance (B) 116 and the distance (A) 110. The vehicle controller may compare the distance between the traffic light 102 and the road intersection centre 106 against a range (D) 122. If the distance (A) 110 is shorter than the distance (B) 116, in other words, the traffic light 102 is further away from the vehicle 108 as compared to the road intersection centre 106, and the sensor unit only detects a single traffic light within the range (D) 122, the vehicle controller may generate the virtual stop line 130 based on the distance (B) 116 and an offset distance (C) 118. The offset distance (C) 118 may be a predefined parameter. The vehicle controller may determine a position of the virtual stop line 130 position to be equal to “distance (B) 116—offset distance (C) 118”. In other words, the position of the virtual stop line 130 may be determined based on a difference between the distance (B) 116 and the offset distance (C) 118.

FIG. 1C shows a scenario where the vehicle 108 is approaching a road crossing 124 with a single traffic light 102. In this scenario, the digital map data does not indicate presence of a road intersection 104. The sensor unit, for example, the front camera, of the vehicle 108 may detect the traffic light 102. The sensor unit may not detect any stop line 114. In the absence of detection of a stop line 114, in combination with detection of the traffic light 102, the vehicle controller may generate the virtual stop line 130 so that the vehicle 108 may stop before reaching the road crossing 124. The vehicle controller or the sensor unit may determine a distance (E) 134 between the vehicle 108 and the traffic light 102. The vehicle controller may generate the virtual stop line 130 based on the distance (E) 134 and a second offset distance (F) 136. The second offset distance (F) 136 may be a predefined distance. The vehicle controller may determine position of the virtual stop line 130 to be equal to “distance (E) 134—second offset distance (F) 136”. In other words, the position of the virtual stop line 130 may be determined based on a difference between the distance (E) 134 and the second offset distance (C) 136.

FIG. 1D shows a scenario where the vehicle 108 is approaching a road crossing 124 and a road intersection 104 with multiple traffic lights 102a, 102b. The digital map data may indicate presence of the road intersection 104. Accordingly, the digital map unit may detect the road intersection ahead of the vehicle 108, and provide the position of the road intersection centre 106. The digital map unit, or the vehicle controller, may determine a longitudinal distance between the road intersection centre 106 and the vehicle 108, also referred herein as distance (A) 110.

The vehicle controller may generate a virtual stop line 130 having a longitudinal position that is at least substantially the same as the nearest traffic light 102a, if the following conditions are satisfied:
(a) Digital map unit detects road intersection 104 with road crossing 124 ahead of the vehicle 108, and provides information on the distance (A) 110;
(b) two or more traffic lights 102a, 102b are detected by a sensor unit of the vehicle 108; and
(c) distance between each traffic light 102a, 102b from the road intersection center 106, for example, measured by the digital map unit or the vehicle controller, is within a defined range (G) 142.

The traffic light 102 may be considered as the nearest traffic light, based on its longitudinal distance from the vehicle 108. The longitudinal distance refers to a displacement in the general direction of the traffic, and may be at least substantially parallel to the lane markings 142. The range (G) 142 may represent a typical length of a road intersection 104, for checking if a plurality of traffic lights, for example traffic lights 102a and 102b exist within the same road intersection 104. If one of the traffic lights is beyond the range (G) 142, the traffic lights may be considered to be situated at different road intersections 104.

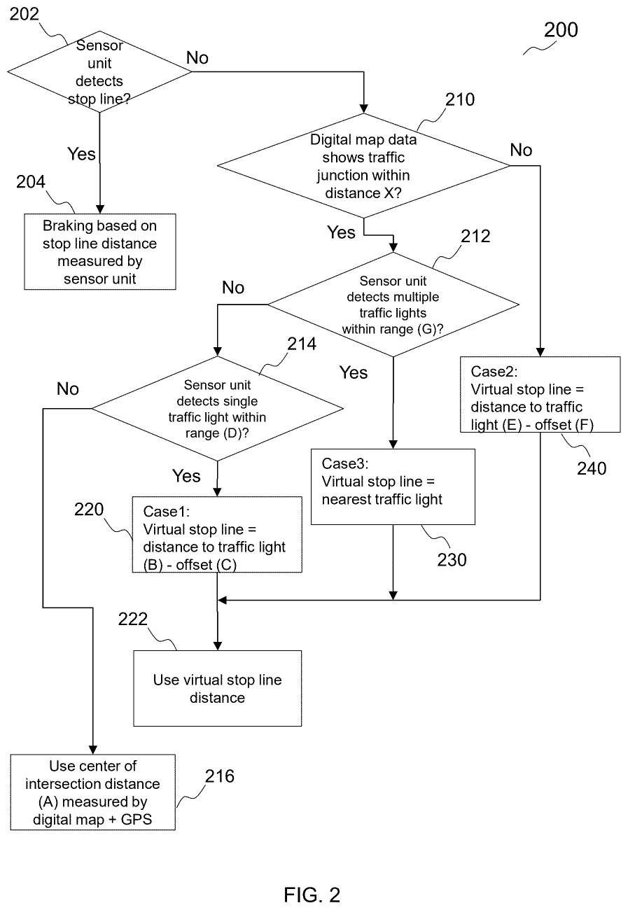

FIG. 1E shows a scenario where the vehicle 108 is approaching a road crossing 124 and a road intersection 104 with a traffic light 102. The sensor unit of the vehicle 108 may not detect the stop line 114. Instead, the sensor unit may erroneously mis-detect another road marking inside the road intersection 104, as the stop line. The stop line detection may be referred herein as a “ghost stop line” 114′, as it is a mis-detection that is not the real stop line 114. If the braking controls of the vehicle 108 were to be guided by the ghost stop line 114′, the vehicle 108 may stop within the road intersection 104, thereby putting itself in danger of collisions with other vehicles passing through the road intersection 104. To prevent the vehicle 108 from braking at the ghost stop line 114′, the vehicle controller may further be configured to suppress such mis-detections. The vehicle controller may monitor a distance 152 between the stop line detection as provided by the sensor unit and the road intersection center 106 as indicated by the digital map unit. If the distance 152 is less than a monitoring threshold, the vehicle controller may determine that the stop line detection may be a ghost stop line 114′. The vehicle controller may suppress the stop line detection, and may disable or prevent a handover to the braking mode. The monitoring threshold may be determined based on area or size of the road intersection 104 and a predefined intersection offset. FIG. 2 show a flow chart of a method 200 for controlling a vehicle 108 according to various embodiments. Various aspects described with respect to FIGS. 1A to 1E may be applicable to the method 200. The method 200 may include determining whether the sensor unit of the vehicle 108 detects a stop line 114, in 202. The method 200 may include generating braking instructions based on the detected stop line in 204, if the sensor unit detects a stop line 114. A distance between the vehicle 108 and the detected stop line 114 may be determined, for generating the braking instructions. The method 200 may include determining whether the digital map data shows a traffic junction within distance “X” in 210, if the sensor unit does not detect a stop line 114. Distance “X” may be a predefined threshold for a longitudinal distance between the vehicle 108 and the traffic junction. Distance “X” may be the “first threshold” described with respect to FIG. 1A. The traffic junction may include a road intersection 104 or a road crossing 124. The method 200 may further include determining, in 212, whether the sensor unit detects more than one traffic light 102 within a range (G) 142, if the digital map data shows a traffic junction within distance “X”. The method 200 may further include determining, in 214, whether the sensor unit detects a single traffic light 102 within range (D), if the sensor unit does not detect multiple traffic lights within range (G) 142 in 212.

The method 200 may include generating, in 216, instructions for braking the vehicle 108 based on a distance between the vehicle 108 and a road intersection centre 106, if the sensor unit 214 does not detect any traffic light 102 within range (D) in 214. The vehicle position may be determined by satellite positioning, for example, a GPS module. The position of the road intersection centre 106 may be determined based on digital map data. The distance between the vehicle 108 and the road intersection centre 106 may be determined by computing a difference between the vehicle position and the position of the road intersection centre 106.

The method 200 may include generating, in 220, a virtual stop line 130 based on a distance of the vehicle 108 to the traffic light 102, i.e. distance (B) 116 and an offset (C) 118, if the sensor unit detects a single traffic light 102 within range (D). In 220, the virtual stop line 130 may be defined such that its longitudinal distance from the vehicle 108 may be at least substantially equal to a difference between distance (B) 116 and the offset distance (C) 118. The method 200 may further include, using a distance of the vehicle 108 to the virtual stop line 130, to generate braking instructions for the vehicle 108, in 222.

The method 200 may include generating, in 230, the virtual stop line 130 based on position of a traffic light 102a nearest to the vehicle 108, if the sensor unit detects multiple traffic lights 102a, b within range (G). In 230, the virtual stop line 130 may be defined such that its longitudinal distance from the vehicle 108 may be at least substantially equal to the distance between the vehicle 108 and the nearest traffic light 102a. The method 200 may further include, using a distance of the vehicle 108 to the virtual stop line 130, to generate braking instructions for the vehicle 108, in 222.

The method 200 may include generating, in 240, the virtual stop line 130 based on distance between the vehicle 108 and the traffic light 102, i.e. distance (E) 134, and second offset distance (F) 136, if the digital map data does not show a traffic junction within distance “X”. In 240, the virtual stop line 130 may be defined such that its longitudinal distance from the vehicle 108 may be at least substantially equal to a difference between distance (E) 134 and the second offset distance (F) 136. The method 200 may further include, using a distance of the vehicle 108 to the virtual stop line 130, to generate braking instructions for the vehicle 108, in 222.

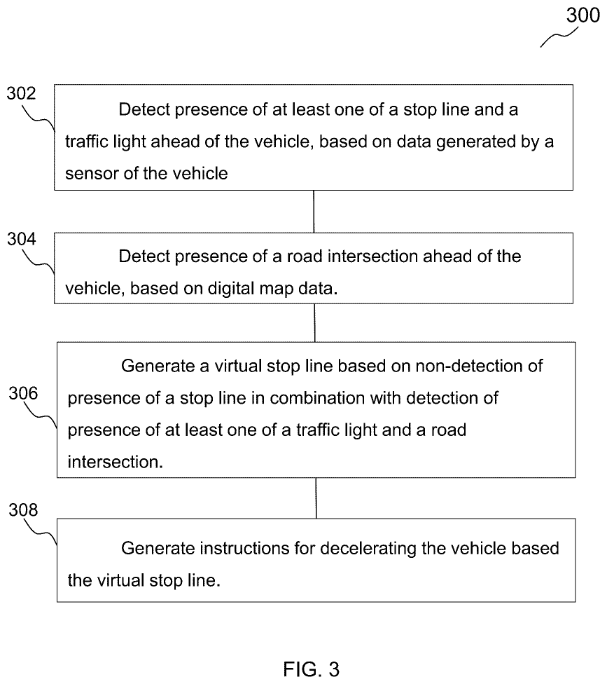

FIG. 3 shows a flow diagram of a computer-implemented method 300 for controlling a vehicle 108 according to various embodiments. The method 300 may include, or may be part of, the method 200. Various aspects described with respect to FIGS. 1A to 1E may be applicable to the method 300. The method 300 may include detecting presence of at least one of a stop line 114 and a traffic light 102 ahead of the vehicle 108 based on data generated by a sensor of the vehicle 108, in 302. The method 300 may further include detecting presence of a road intersection 104 ahead of the vehicle 108based on digital map data, in 304. The method 300 may further include generating a virtual stop line 130 based on non-detection of presence of a stop line 114 in combination with detection of presence of at least one of a traffic light 102 and a road intersection 104, in 306. The method 300 may further include generating instructions for decelerating the vehicle 108 based on the virtual stop line 130, in 308. Advantageously, the method 300 may assist a driver, or an autonomous vehicle, in braking to a stop before approaching a traffic junction such as a road crossing 124 or a road intersection 104.

According to an embodiment which may be combined with any above described environment or with any below described further embodiment, decelerating the vehicle 108 based on the virtual stop line 113 may include decreasing speed of the vehicle 108 until the vehicle 108 stops at a position of the virtual stop line 130. This may ensure that the vehicle 108 does not move into dangerous zones such as road intersections or a road crossing.

According to an embodiment which may be combined with any above described environment or with any below described further embodiment, generating the virtual stop line 130 may include determining a first distance between the vehicle 108 and the at least one of the traffic light 102 and a centre of the road intersection 104, and positioning the virtual stop line 130 based on the determined first distance. The first distance may be measured in a longitudinal direction that is at least substantially parallel to a general traffic direction on the road. Advantageously, this enables the vehicle 108 to start distance control deceleration against the traffic light even if the real stop line 114 cannot be detected.

According to an embodiment which may be combined with any above described environment or with any below described further embodiment, positioning the virtual stop line based on the determined first distance may include deducting an offset distance from the first distance. The offset distance may be, for example, the offset distance (C) 118 or the second offset distance (F) 136.

According to an embodiment which may be combined with any above described environment or with any below described further embodiment, when presence of both the traffic light 102 and the road intersection 104 are detected, and wherein the traffic light 102 is further away from the vehicle 108 than a centre of the road intersection 104, the first distance is a distance between the vehicle 108 and the traffic light. In other words, the first distance may be the distance (B) 116.

According to an embodiment which may be combined with any above described environment or with any below described further embodiment, the method 300 may further include determining a position of the stop line 114 in response to detecting presence of the stop line, and generating the instructions for decelerating the vehicle 108 based on the determined position of the stop line 114. Advantageously, the vehicle 108 may be prevented from stopping at the wrong position even if the stop line is falsely detected.

According to an embodiment which may be combined with any above described environment or with any below described further embodiment, the method 300 may further include determining a second distance between the stop line and a centre of the road intersection 104 based on detection of the road intersection, and verifying the presence of the stop line 114 based on the determined second distance. The second distance may be the distance 152 described with respect to FIG. 1E. Advantageously, the method 300 may prevent the vehicle 108 from stopping within a road intersection due to incorrect determination of the stop line position.

According to an embodiment which may be combined with any above described environment or with any below described further embodiment, verifying the presence of the stop line 114 may include comparing the second distance to a monitoring threshold, and determining that detection of the stop line is a false detection based on the second distance being shorter than the monitoring threshold. The monitoring threshold may serve as a reference to confirm whether the stop line detection is at an impossible position, thereby improving accuracy of the stop line detection.

According to an embodiment which may be combined with any above described environment or with any below described further embodiment, the method 300 may further include generating instructions for decelerating the vehicle based on the virtual stop line 130 instead of the determined position of the stop line in response to determining that the stop line detection is a false detection. Advantageously, this may direct the vehicle 108 to stop at an appropriate position before reaching a road junction.

According to an embodiment which may be combined with any above described environment or with any below described further embodiment, a plurality of traffic lights 102 is detected in the data generated by the sensor, and the method 300 may further include: determining respective first distances of each traffic light 102 of the plurality of traffic lights 102 to the vehicle 108, and generating the virtual stop line 130 based on the shortest first distance. Advantageously, this directs the vehicle 108 to stop before the nearest traffic junction.

According to an embodiment which may be combined with any above described environment or with any below described further embodiment, decelerating the vehicle 108 based on the virtual stop line 130 may include non-linearly decreasing speed of the vehicle 108. Advantageously, the vehicle 108 may decelerate gently upon detection of a road intersection, and increase deceleration when the vehicle approaches the road intersection or when the virtual stop line 130 is generated.

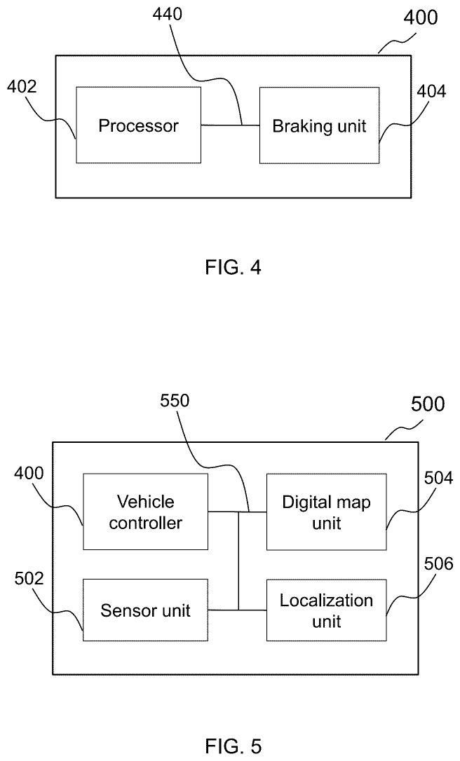

FIG. 4 shows a simplified block diagram of a vehicle controller 400 according to various embodiments. The vehicle controller 400 may include at least one processor 402. The processor 402 may be, for example, an automated driving control unit (ADCU). The processor 402 may be configured to carry out the method 200 or the method 300 in any above-described embodiment. The vehicle controller 400 may equip the vehicle 108 with the capability to brake to a stop before approaching a traffic junction such as a road crossing 124 or a road intersection 104. This is especially useful for the vehicle 108 to move around safely in urban settings.

According to an embodiment which may be combined with any above described environment or with any below described further embodiment, the vehicle controller 400 may further include a braking unit 404. The braking unit 404 may be configured to decelerate the vehicle 108 according to instructions generated by the processor 402. The braking unit 404 may include, for example, hydraulic brakes. The processor 402 and the braking unit 404 may be coupled to one another, for example, mechanically or electrically, via coupling line 440. The vehicle controller 400, being integrated with the braking unit 404, may efficiently execute the braking instructions to stop the vehicle.

FIG. 5 shows a simplified block diagram of a vehicle 500 according to various embodiments. The vehicle 500 may include, or may be part of, the vehicle 108. The vehicle 500 may include the vehicle controller 400 and a sensor unit 502. The sensor unit 502 may be configured to generate data indicative of objects ahead of the vehicle 500. The sensor unit 502 may include a sensor, such as a camera. The sensor unit 502 may be configured to detect objects, for example, another vehicle, a stop line 114, a traffic light 102, among others, based on data generated by the sensor.

According to an embodiment which may be combined with any above described environment or with any below described further embodiment, the vehicle 500 may further include a digital map unit 504. The digital map unit 504 may store digital map data in an onboard memory, or may receive digital map data from a remote server. The digital map data may include information on landmarks such as traffic lights 102, and also information on the road layout, such as positions of road intersections, road crossings and more. The digital map unit 504 may provide the digital map data to the vehicle controller 400.

According to an embodiment which may be combined with any above described environment or with any below described further embodiment, the vehicle 500 may further include a localization unit 506. The localization unit 506 may be configured to localize the vehicle 500. In other words, the localization unit 506 may be configured to determine a position or location of the vehicle 500. The localization unit 506 may include a transceiver configured to receive satellite signals. The localization unit 506 may include a GPS and/or an inertial measurement unit. The localization unit 506 may provide location of the vehicle 500 to the vehicle controller 400.

The vehicle controller 400, the digital map unit 504, the sensor unit 502, and the localization unit 506 may be coupled to one another, for example, mechanically or electrically, via coupling line 550.

Various aspects described with respect to the method 300 may be applicable to the vehicle controller 400 and the vehicle 500.

According to various embodiments, a computer program product may be provided. The computer program product may include instructions. When the program is executed by a computer, the instructions may cause the computer to carry out the steps of the method 300. The computer may include, for example, the processor 402.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

It will be appreciated to a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for controlling a vehicle, the method comprising:
detecting presence of at least one of a stop line and a traffic light ahead of the vehicle, based on data generated by a sensor unit of the vehicle;
detecting presence of a road intersection ahead of the vehicle, based on digital map data;
generating a virtual stop line based on non-detection of presence of a stop line in combination with detection of presence of at least one of a traffic light and a road intersection (104); and
generating instructions for decelerating the vehicle based on the virtual stop line.

2. The method of claim 1, wherein decelerating the vehicle based on the virtual stop line comprises decreasing speed of the vehicle until the vehicle stops at a position of the virtual stop line.

3. The method of claim 1, wherein generating the virtual stop line comprises determining a first distance between the vehicle and the at least one of the traffic light and a centre of the road intersection, and positioning the virtual stop line based on the determined first distance.

4. The method of claim 3, wherein positioning the virtual stop line based on the determined first distance comprises deducting an offset distance from the first distance.

5. The method of claim 3, wherein when presence of both the traffic light and the road intersection are detected, and wherein the traffic light is further away from the vehicle than a centre of the road intersection, the first distance is a distance between the vehicle and the traffic light.

6. The method of claim 1, further comprising:
determining a position of the stop line in response to detecting presence of the stop line; and
generating the instructions for decelerating the vehicle based on the determined position of the stop line.

7. The method of claim 6, further comprising:
determining a second distance between the stop line and a centre of the road intersection based on detection of the road intersection; and
verifying the presence of the stop line based on the determined second distance.

8. The method of claim 7, wherein verifying the presence of the stop line comprises comparing the second distance to a monitoring threshold, and determining that detection of the stop line is a false detection based on the second distance being shorter than the monitoring threshold.

9. The method of claim 8, further comprising:
generating instructions for decelerating the vehicle based on the virtual stop line instead of the determined position of the stop line in response to determining that the stop line detection is a false detection.

10. The method of claim 1, wherein a plurality of traffic lights is detected in the data generated by the sensor unit the method further comprising:
determining respective first distances of each traffic light of the plurality of traffic lights to the vehicle; and
generating the virtual stop line based on the shortest first distance.

11. The method of claim 1, wherein decelerating the vehicle based on the virtual stop line comprises non-linearly decreasing speed of the vehicle.

12. A vehicle controller comprising:
a processor configured to perform a computer-implemented method for controlling a vehicle,
wherein the method comprises
detecting presence of at least one of a stop line and a traffic light ahead of the vehicle, based on data generated by a sensor unit of the vehicle;
detecting presence of a road intersection ahead of the vehicle, based on digital map data;
generating a virtual stop line based on non-detection of presence of a stop line in combination with detection of presence of at least one of a traffic light and a road intersection; and
generating instructions for decelerating the vehicle based on the virtual stop line.

13. The vehicle controller of claim 12, further comprising:
a braking unit configured to decelerate the vehicle according to the instructions generated by the processor.

14. (canceled)

15. A non-transitory computer-readable medium comprising instructions, which, when the program is executed by a computer, cause the computer to carry out the steps of a computer-implemented method for controlling a vehicle,
wherein the method comprises
detecting presence of at least one of a stop line and a traffic light ahead of the vehicle, based on data generated by a sensor unit of the vehicle;
detecting presence of a road intersection ahead of the vehicle, based on digital map data;
generating a virtual stop line based on non-detection of presence of a stop line in combination with detection of presence of at least one of a traffic light and a road intersection; and
generating instructions for decelerating the vehicle based on the virtual stop line.
